(19) United States
(12) Patent Application Publication
(10) Pub. No.: US 2016/0082575 A1
(43) Pub. Date: Mar. 24, 2016

(54) OPERABLE RATCHET WRENCH

(71) Applicant: TSAI SHUN YU, Taichung City (TW)

(72) Inventor: TSAI SHUN YU, Taichung City (TW)

(21) Appl. No.: 14/857,172

(22) Filed: Sep. 17, 2015

(30) Foreign Application Priority Data
Sep. 19, 2014 (TW) 103132478

(51) Int. Cl. B25B 13/46; B25B 13/14

(52) U.S. Cl. CPC B25B 13/46; B25B 13/14

(57) ABSTRACT

The present invention is directed to an operable ratchet wrench, which comprises a fixing jaw, a sliable jaw, a movable assembly, a handle, a stop pin and a driving notch. The slidable jaw is slidably disposed in the fixing jaw. The movable assembly is capable of moving axially in the fixing jaw to urge the slidable jaw to slide away. The handle is pivoted on the fixing jaw and capable of swinging with the fixing jaw. The stop pin is disposed in the handle. The stop pin is moved from a first position where the movable assembly is stopped from axial movement to a second position where the movable assembly is free for axial movement in response to swing operation of the handle. The driving notch is configured to allow the handle rotating relative to the fixing jaw. The present invention is provided with a convenient ratchet wrench.

### BACKGROUND OF INVENTION

1. Field of Invention

The invention relates to a ratchet wrench, and more especially to an operable ratchet wrench that can be efficiently reversibly rotated.

2. Related Prior Art

Please refer to FIG. 12, which is a cross-sectional view showing a conventional ratchet wrench. The conventional ratchet wrench 9 features a ratcheting function. Specifically, when the conventional ratchet wrench is applied to drive a hexagonal nut to rotate reversibly, which offers a force C1 on the hexagonal nut A, it is well known that there exist a resistance force C2 between the hexagonal nut and a tapped hole of a working piece that is against the force C1. The fixing jaw 90 thereof is temporarily fastened by the resistance force C2, which allows the handle 95 slightly being away from the fixing jaw 90 about its pivot pin 951 and allows the stop pin 96 being moved away from its original position. The movable jaw 91 that is not withheld by the stop pin 96 is thus pushed outward against two heads A1, A2 of the hexagonal nut A. As such, the hexagonal bolt A would not be rotated along with the conventional ratchet wrench 9 when the wrench 9 is reversibly turned. It is thus noted that the conventional ratchet wrench 9 is designed to be reversible, in which they can drive the hexagonal nut in one direction and as well run idle in the reverse direction, so that they would not have to disengage from the nut after every turning stroke.

However, the conventional ratchet wrench has a problem while using. FIG. 13 is a cross-sectional view of the conventional ratchet wrench. During the process of disengaging the hexagonal nut A, the resistance force C2 between the hexagonal nut A and the tapped hole gets less and less, which means that the resistance force C2 may not overcome the force C1. It thus causes that the fixing jaw 90 of the conventional ratchet wrench 9 cannot be temporarily fastened, and thereby the hexagonal nut A is rotated with the conventional ratchet wrench 9. The ratchet wrench 9 therefore don't feature ratchet function.

Besides, as shown in FIG. 14, which shows the conventional ratchet wrench 9. The compression spring 93 is placed in the through hole 92. The movable jaw 91 urges the sliding rod 94 to slide outward, enabling the compression spring 93 being depressed by the sliding rod 94 simultaneously. Meanwhile, the compression spring 93 offers an elastic force that enables the sliding rod 94 and the movable jaw 91 moving back to its original position. However, if a force D, that the hexagonal nut A pushes against the movable jaw 91 away from the fixing jaw 90 to allow the sliding rod 94 sliding outward simultaneously, cannot overcome the elastic force E that the compressing spring 93 pushes against the sliding rod 94, the movable jaw 91 cannot well slide away from the fixing jaw 90 and is thus stuck at a position of being against the two heads A1, A2 of the hexagonal nut.

### SUMMARY OF INVENTION

The present invention is related to an operable ratchet wrench with features ratcheting functions, which permits a handle thereof to be efficiently reversibly rotated.

Specifically, the present invention is directed to an operable ratchet wrench, which comprises a fixing jaw, a slidable jaw, a handle, worm shaft, an axial rod, a spring, a stop pin and a driving notch.

The fixing jaw includes a body and a sector block extending from a bottom of the body. The body has a sliding rail, a receiving slot communicating with the sliding rail, a through bore parallel with the sliding rail and a connecting bore communicating with the through bore. The through bore communicates with the receiving slot. The sector block has a first groove defined in an arc edge of the sector block.

The slidable jaw includes a sliding rod slidably disposed in the sliding rail of the fixing jaw. The slidable jaw is capable of moving in the sliding rail with respect to the fixing jaw.

The worm shaft has an axial bore defined therethrough. The worm shaft is installed in the receiving slot of the fixing jaw and engaged with a toothed portion of the sliding rod of the slidable jaw.

The axial rod is inserted through the through bore, the receiving slot and the axial bore of the worm shaft. The axial rod is axially movable in the through bore along an axial direction thereof. The axial rod has a stop portion stopping against a bottom rim of the worm shaft.

The spring is disposed in the through bore for allowing the axial rod being elastically movable along the axial direction.

The handle has a pivot trench, a recess, switch slot and a through hole each defined in a head portion thereof, respectively. The pivot trench is applied for receiving the sector block therein. The handle is pivoted on a vertex of the sector block. The handle is capable of being swung with respect to the sector block. The recess faces the connecting bore of the fixing jaw. The switch slot is defined through a wide wall of the pivot trench and communicates the pivot trench. The through hole is defined through a narrow wall of the pivot trench and communicates with the pivot trench. The through hole is perpendicular to the switch slot. The through hole is located in a position where is adjacent to the recess and faces the first groove of the sector block. The through hole communicates with the switch slot.

A top section of the stop pin is inserted through the connecting bore of the fixing jaw and enters in the through bore to abut against the axial rod. A bottom section of the stop pin enters in the recess of the handle and is pivoted with the handle.

The driving notch is dented inward in the pivot trench of the handle. The driving notch is located in a position where is close to a bottom meeting apex of the sector block and the pivot trench so as to uncover a part of the sector block from the pivot trench.

Preferably, the driving notch can be replaced with a driving bulge. The driving bulge juts out from the sector block. The driving bulge is located in a position where is close to a bottom meeting apex of the sector block and the pivot trench so as to uncover the driving bulge from the pivot trench.

Preferably, the operable ratchet wrench of the present invention further comprises a resilient element disposed in an accommodating bore of the fixing jaw in a compression state. The resilient element abuts against the axial rod with an elastic force.

Preferably, the operable ratchet wrench of the present invention further comprises a switch assembly. The switch assembly is installed in the switch slot and capable of moving in the switch slot. The switch assembly has a unlock position where keeps the switch assembly away from the first groove when the switch assembly is moved thereto and a lock position where enables the switch assembly entering in the first groove when the switch assembly is moved thereto. The switch assembly includes a control piece and a locking post. The locking post is disposed in the through hole and capable of moving into the first groove. The control piece has an engaging end that enters in the switch hole and the through hole. The engaging end of the control piece is connected to the locking post. The control piece further has a control end protruding from the switch hole.

Preferably, the operable ratchet wrench of the present invention further comprises a return assembly. The return assembly includes a return spring and an axle. The return spring is disposed in a second groove that is defined in the arc edge of the sector block. The axle is securely disposed in the handle. A portion of the axle is located in the second groove and abuts against the return spring.

Accordingly, the operable ratchet wrench of the present invention is configured to maintain its ratcheting function and to be capable of being reversibly rotated after disengage the hexagonal nut.

Other features, objects, aspects and advantages will be identified and described in detail below.

### BRIEF DESCRIPTION OF DRAWINGS

FIG. 1 is a stereo perspective view of an operable ratchet wrench in accordance with an embodiment of the present invention.

FIG. 2 is an exploded stereo perspective view of the operable ratchet wrench in accordance with an embodiment of the present invention.

FIG. 3 is an exploded stereo perspective view showing a part of the operable ratchet wrench from a view angle in accordance with an embodiment of the present invention.

FIG. 4 is an exploded stereo perspective view showing a part of the operable ratchet wrench from another view angle in accordance with an embodiment of the present invention.

FIG. 5 to FIG. 8 are cross-sectional views showing a process of reversibly rotating the handle when the operable ratchet wrench is switched to a ratcheting mode.

FIG. 9 is a cross-sectional perspective view of the operable ratchet wrench in accordance with an embodiment of the present invention.

FIG. 10 is a perspective view showing that the operable ratchet wrench is switched to a traditional mode in accordance with an embodiment of the present invention.

FIG. 11 is a cross-sectional perspective view of another embodiment of the present invention.

FIG. 12 is a cross-sectional view showing a conventional ratchet wrench.

FIG. 13 is a cross-sectional view showing a conventional ratchet wrench.

FIG. 14 is a cross-sectional view showing a conventional ratchet wrench.

### DETAILED DESCRIPTION OF EMBODIMENTS

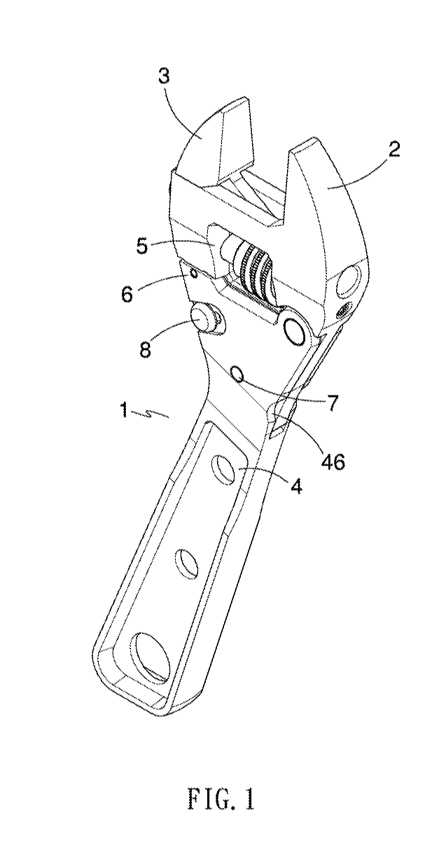

FIG. 1 to FIG. 4 are perspective drawings showing an embodiment of the present invention. With reference to FIG. 1, the operable ratchet wrench 1 comprises a fixing jaw 2, a slidable jaw 3, a handle 4, a movable assembly 5, a resisting assembly 6, a return assembly 7 and a driving notch 46.

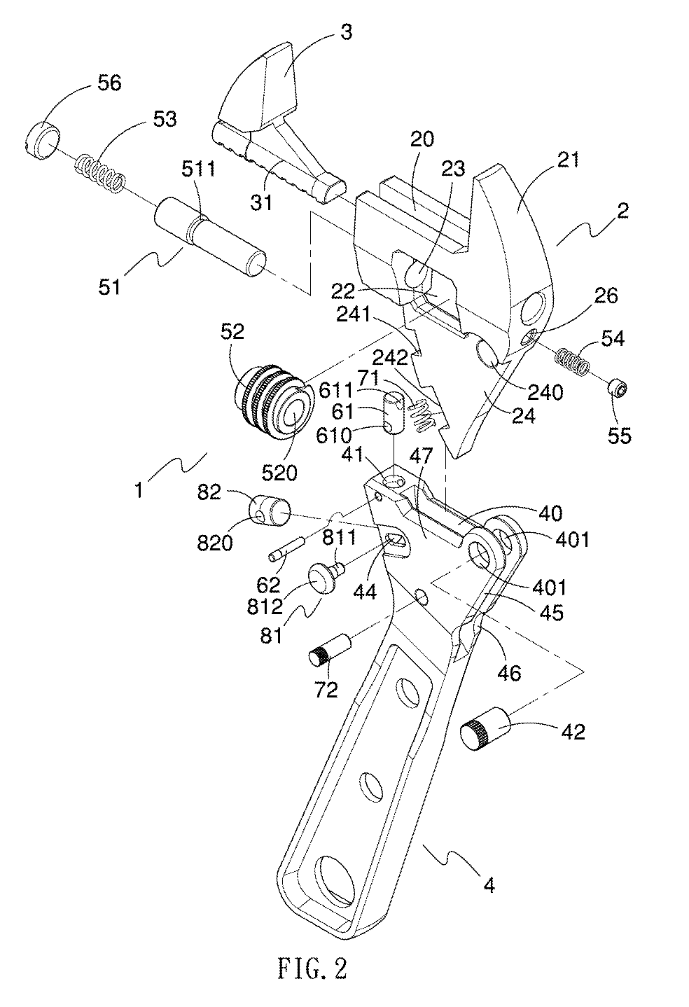

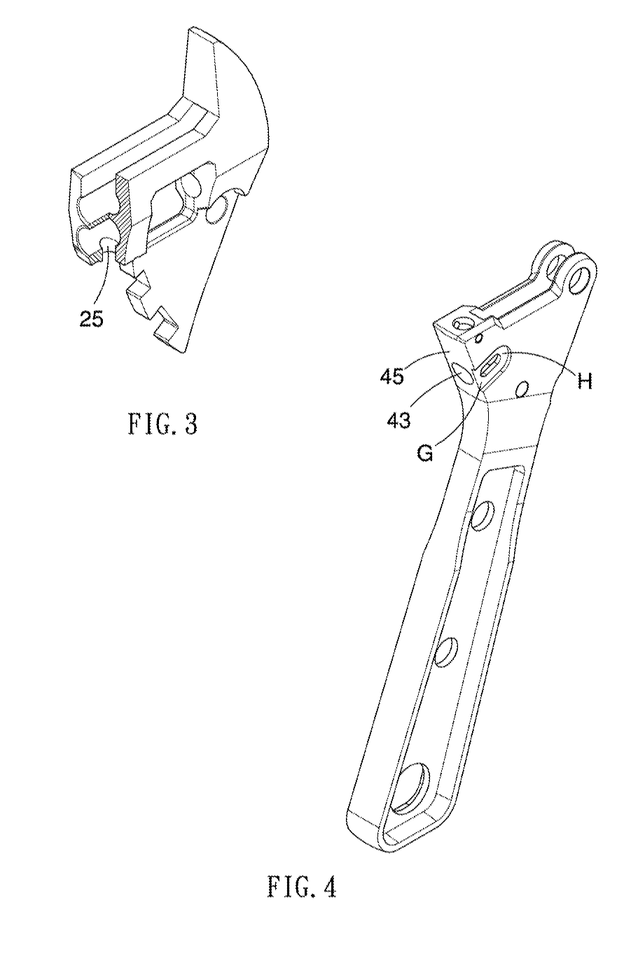

With reference to FIG. 2, the fixing jaw 2 includes a body 21, and the body 21 has a sliding rail 20 and a receiving slot 22 defined therein. The sliding rail 20 is defined above the receiving slot 22 and communicates with the receiving slot 22. The fixing jaw 2 further includes a through bore 23, an accommodating bore 26 and a connecting bore 25 defined therein. The through bore 23 and the accommodating bore 26 are parallel with the sliding rail 20. The connecting bore 25 is vertical to the through bore 23 (as shown in FIG. 3). One end of the through bore 23 communicates with the outside and the other end of the through bore 23 communicates with the receiving slot 22. One end of the accommodating bore 26 communicates with the outside and the other end thereof communicates with the receiving slot 22. With reference to FIG. 3, one end of the connecting bore 25 communicates with the outside and the other end thereof vertically communicates with the through bore 23. The fixing jaw 2 further includes a sector block 24 vertically extending from the bottom of the body 21. The sector block 24 has a first pivot bore 240 defined in a position where is close to a vertex of the sector block 24, a first groove 241 and a second groove 242. Both of the first groove 241 and the second groove 242 are defined in an arc edge of the sector block 24.

The slidable jaw 3 has a sliding rod 31 slidably disposed in the sliding rail 20 of the fixing jaw 2.

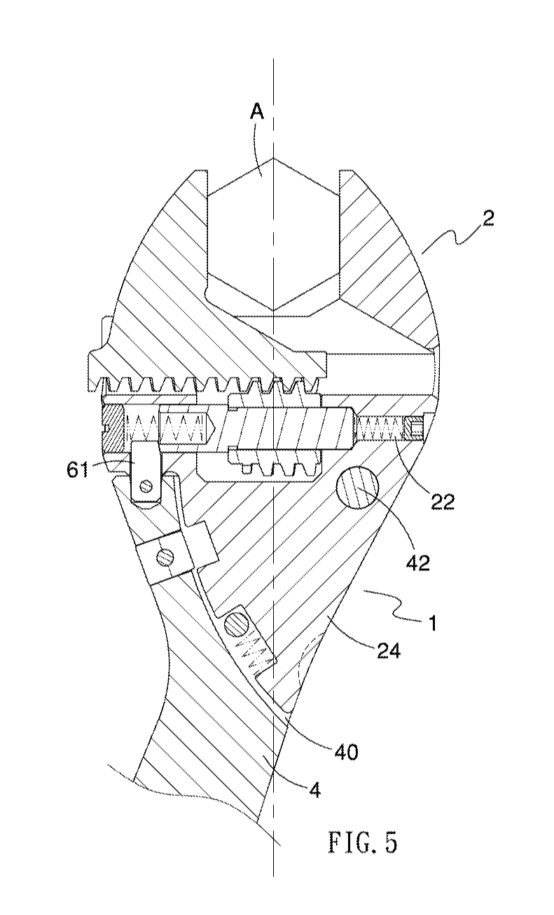

The handle 4 includes a pivot trench 40 and a recess 41 each defined at a head portion of the handle 4. The sector block 24 of the fixing jaw 2 is inserted into the pivot trench 40. The handle 4 further includes a pivot axle 42 inserted through the first pivot bore 240 of the sector block 24 and two second pivot bores 401 of the handle, such that the handle 4 is swingingly pivoted on the fixing jaw 2 about the pivot axle 42. The recess 41 faces the connecting bore 25 of the fixing jaw 2 and is adjacent to a through hole 43 (as shown in FIG. 4).

The movable assembly 5 includes an axial rod 51, a worm shaft 52, a spring 53, a resilient element 54, a fastener 55 and a joining pin 56. The worm shaft 52 has an axial bore 520 defined therethrough. The worm shaft 52 is installed in receiving slot 22 of the fixing jaw 2. The worm shaft 52 is engaged with a toothed portion of the sliding rod 31 of the slidable jaw 3. Besides, the axial rod 51 is inserted through the through bore 23, the receiving slot 22 and the axial bore 520 of the worm shaft 52. The axial rod 51 is axially movable in the through bore 23 along an axial direction of the through bore. The axial rod 51 has a stop portion 511 formed thereon, which stops against a bottom rim of the worm shaft 52. The joining pin 56 is screwed into the through bore 23 and has a distance from the axial rod 51. The spring 53 is disposed in the through bore 23, allowing the axial rod 51 being elastically movable along the axial direction. In this embodiment, the resilient element 54 is preferably a compression spring, which is disposed in the accommodating bore 26 in a compression state and abuts against the axial rod 51. The fastener 55 is fastened in the accommodating bore 26, which is adjacent to the outside, and the fastener 55 abuts against the resilient element 54.

The resisting assembly 6 includes a stop pin 61 and an inserting pin 62. The stop pin 61 has a top section and a bottom section. The top section of the stop pin 61 is inserted in the connecting bore 25 of the fixing jaw 2, protruding in the through bore 23 and abutting against an end of the axial rod 51, which keeps the axial rod 51 from moving along the axial direction. The bottom section of the stop pin 61 protrudes through from the connecting bore 25, and enters the recess 41 of the handle 4 with a gap between the recess 41 and the bottom section of the stop pin 61. It is noted that the gap between exterior surfaces of the bottom section of the stop pin 61 and interior walls of the recess 41 of the handle 4 allows the stop pin 61 being slightly swung in the recess 41 with respect to the recess 41. This ensures that the stop pin 61 can be easily withdrawn from the through bore 23 along with the swing of the handle 4 with respect to the fixing jaw 2. The stop pin 61 has an inserting hole 610 and an inclined plane 611. The inserting pin 62 passes through the inserting hole 610 of the stopping pin 61, which is fixed in the handle 4 for being pivoted with the bottom section of the stop pin 61 in the handle 4. Noted that there is a clearance between the inclined place 611 of the stop pin 61 and the connecting bore 25 of the fixing jaw 2.

The return assembly 7 includes a return spring 71 and an axle 72. The return spring 71 is disposed in the second groove 242 of the sector block 24. The axle 72 is fixed in the handle 4. A portion of the axle 72 is located in the second groove 242 and abuts against an end of the return spring 71 in the second groove 242.

In this embodiment, the driving notch 46 is in a form of a concave in a narrow wall 45 of the pivot trench 40. Specifically, the driving notch 46 is dented inward in the narrow wall 45 of the pivot trench 40 and is located in a position where it is close to a bottom meeting apex of the pivot trench 40 and the sector block 24. When the sector block 24 is installed within the pivot trench 40, a part of the sector block 24 is exposed, which means that a part of the sector block 24 uncovers from the pivot trench 40 due to the driving notch 46. As such, the uncovered sector block 24 can be pressed, which enables the handle 4 being reversely rotatable with respect to the sector block 24 of the fixing jaw 2 about the pivot axle 42 and allows the stop pin 61 being withdrawn simultaneously, without keeping the fixing jaw 2 fixed.

Preferably, in the present invention, the pivot trench 40 further has a through hole 43 and a switch slot 44. The switch slot 44 is in a form of an elongated elliptical shape and defined through a wide wall 47 of the pivot trench 40. The switch slot 44 communicates the pivot trench 40. With respect to FIG. 4, the through hole 43 is defined in another narrow wall 45 of the pivot trench 40 and communicates with the pivot trench 40. The through hole 43 is located in a position where is adjacent to the recess 41 and faces the first groove 241 of the sector block 24. The through hole 43 is perpendicular to the switch slot 44 and communicates the switch slot 44.

Preferably, the operable ratchet wrench 1 of the present invention further comprises a switch assembly 8 that is installed in the switch slot 44 and is capable of moving in the switch slot 44. The switch assembly 8 is configured with a lock position H and a unlock position G. Specifically, when the switch assembly 8 is moved at the lock position H in the switch slot 44, the operable ratchet wrench 1 is then switched to a traditional mode that features non-ratcheting function. At this situation, the switch assembly 8 at least partially occupies with the first groove 241 to restrain the sector block 24, which ensures the handle 4 not being slightly reversibly rotated with respect to the sector block 24 of the fixing jaw 2 about the pivot axle 42. When the switch assembly 8 is moved at the unlock position G in the switch slot 44, the operable ratchet wrench 1 is then switched to a ratcheting mode that obviously features ratcheting function. At this situation, the switch assembly 8 is away from the first groove 241, and do not restrain the sector block 24. This permits the handle 4 being slightly reversibly rotated with respect to the sector block 24 of the fixing jaw 2 about the pivot axle 42, and keeping the stop pin 61 being withdrawn as well.

Preferably, the switch assembly 8 includes a control piece 81 and a locking post 82. The locking post 82 is a cylinder-like shape and has an engaging hole 820. The locking post 82 is disposed in the through hole 43 and capable of moving at the first groove 241. The engaging hole 820 of the locking post 82 faces the switch hole 44. The control piece 81 has an engaging end 811 protruding through the switch slot 44, the through hole 43 and the engaging hole 820, which allows the control piece 81 being engaged with the locking post 82. The control piece 81 further has a control end 812 protruded from the switch slot 44. The control end 812 can be moved by a user so as to enable the switch assembly 8 being moving in the switch slot 44.

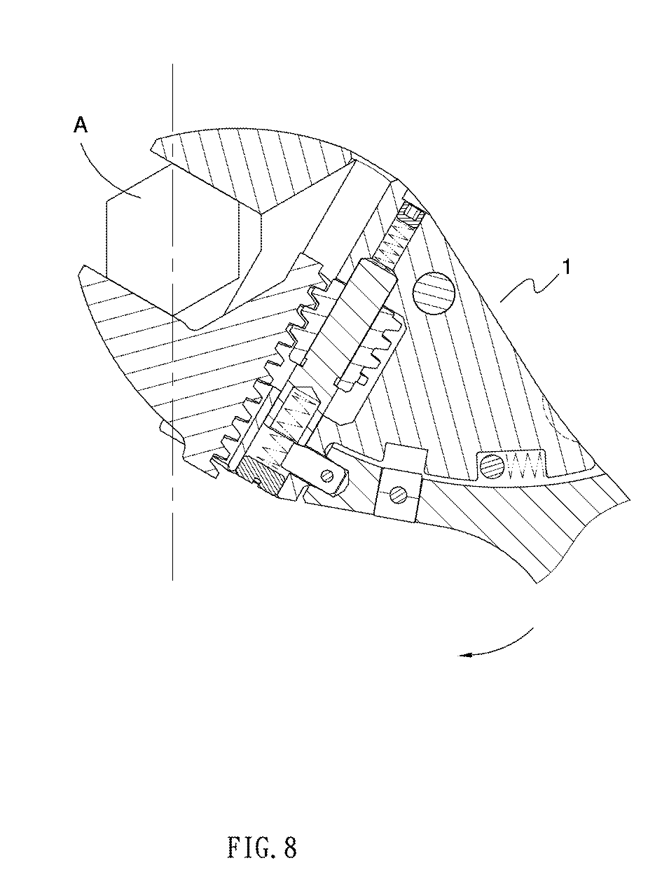

FIG. 5 to FIG. 8 are perspective views showing a process of disengaging a hexagonal nut A by pressing an exposed portion of the sector block 24 and by reversibly rotating the handle 4 when the operable ratchet wrench 1 is switched to a ratcheting mode. During the process of driving the hexagonal nut A to be disengaged by the ratchet wrench 1, the hexagonal nut A is getting loose. The less tightness of the hexagonal nut A screwed in a corresponding screw hole gets, the less resistance that the hexagonal nut A resists the action of the operable ratchet wrench 1 being reversibly rotated exists. At this situation, when a user desires to further reversibly rotate the handle 4 of the operable ratchet wrench 1 that enables the ratchet wrench 1 being rotated from a position of FIG. 5 to another position of FIG. 8, it causes the resistance of the hexagonal nut A being unable to overcome the force of reversibly turning the operable ratchet wrench 1. This would render the hexagonal nut A being rotated with the operable ratchet wrench 1. Thus, it is impossible to make the handle 4 slightly opened with respect to the fixing jaw 2 that is temporally fixed, about the pivot axle 42, and not to make the stop pin 61 being pushed down as well.

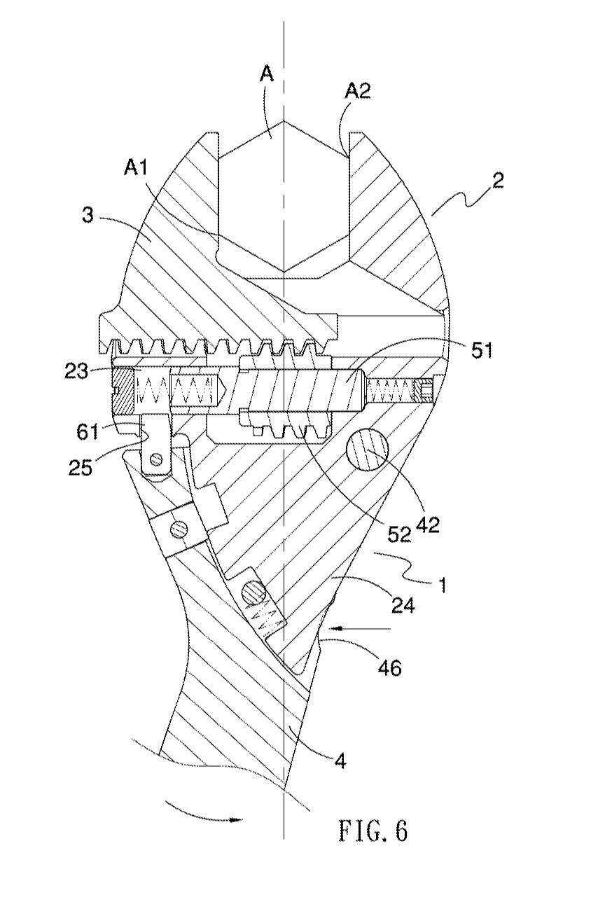

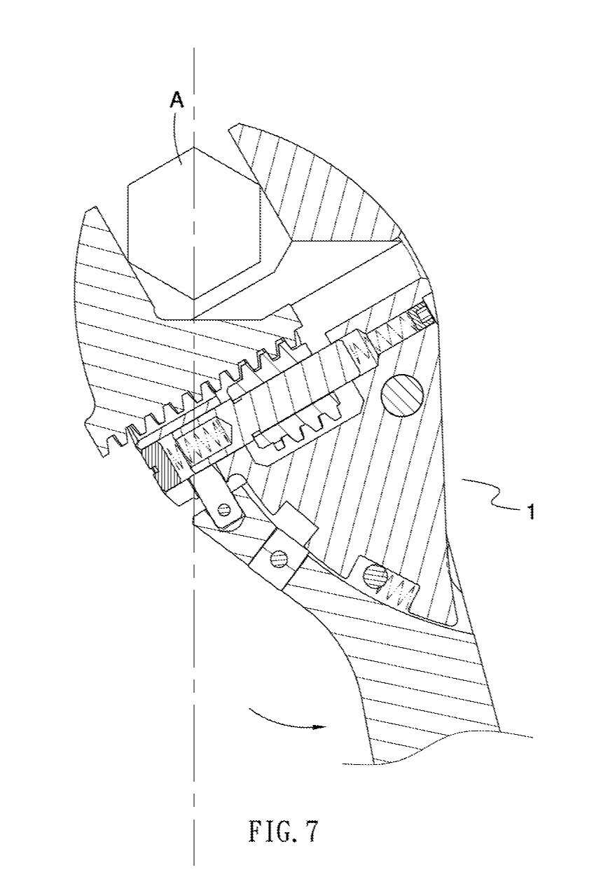

As shown in FIG. 6, pressing the exposed portion of the sector block 24 makes the handle 4 being reversibly rotated about the pivot axle 42 and makes the stop pin 61 being withdrawn as well, without keeping the fixed jaw 2 fixed. As such, the top section of the stop pin 61 is withdrawn from the through bore 23 back to the connecting bore 25. Meanwhile, the axial rod 51 is not restrained by the stop pin 61, which accordingly the slidable jaw 3, the axial rod 51 and the worm shaft 52 can be simultaneously pushed away by two heads A1, A2 of the hexagonal nut A even if the hexagonal nut A is loosened enough to resist the force of reversible rotation of the operable ratchet wrench 1. Hence, as shown in FIG. 7, the operable ratchet wrench 1 can be efficiently rotated without simultaneously turning the hexagonal nut A, which means that the operable ratchet wrench 1 still have the ratcheting function. As shown in FIG. 8, the operable ratchet wrench 1 can be well re-engaged with the hexagonal nut A from a position of FIG. 7.

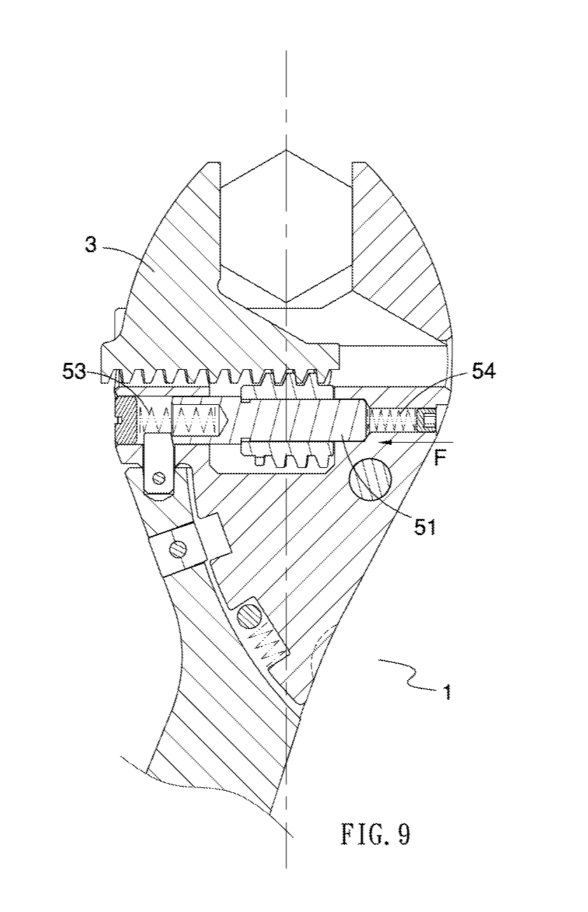

FIG. 9 is a cross-sectional perspective view of the operable ratchet wrench 1 in accordance with an embodiment of the present invention. It is understood that the operable ratchet wrench 1 still cannot disengage with the hexagonal nut A if the force that the hexagonal nut A pushes against the sildable jaw 3 to drive the axial rod 51 moving outward is less than the force that the spring 53 pushes against the axial rod 51. The operable ratchet wrench 1 of the present invention can further comprise a resilient element 54 disposed in the accommodating bore 26. The resilient element 54 is applied to offer an elastic force F pushing the axial rod 51 outwardly. The elastic force F of the resilient element 54 diminishes the force that the spring 53 pushes against the axial rod 51, thereby allowing the slidable jaw 3 being moved outward by pushed by the hexagonal nut A. It therefore evidences that the axial rod 51 is moved outward by the movement of the slidable jaw 3 as well. As such, the operable ratchet wrench 1 of the present invention 1 can be well operated even when the hexagonal nut A screwed in a working piece gets rather low resistance.

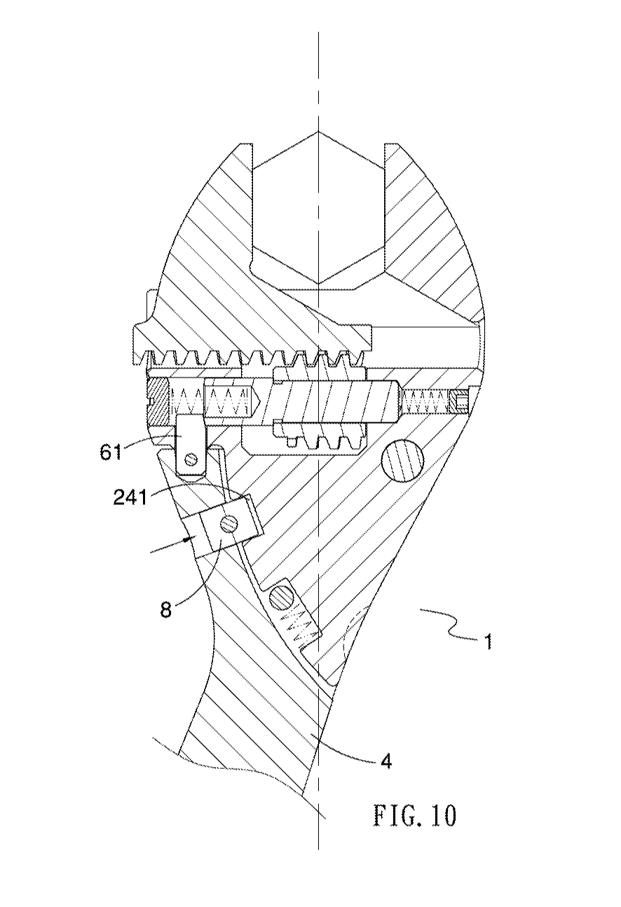

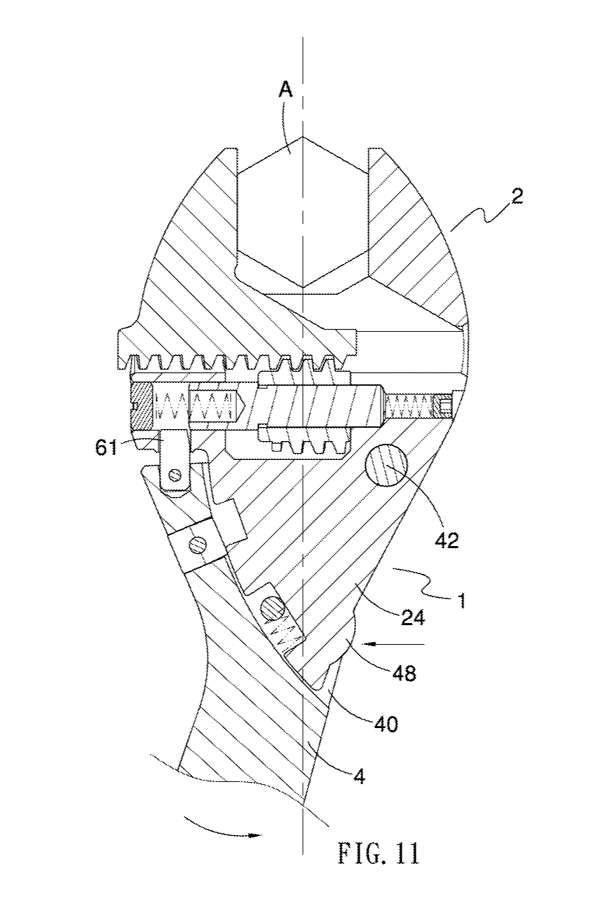

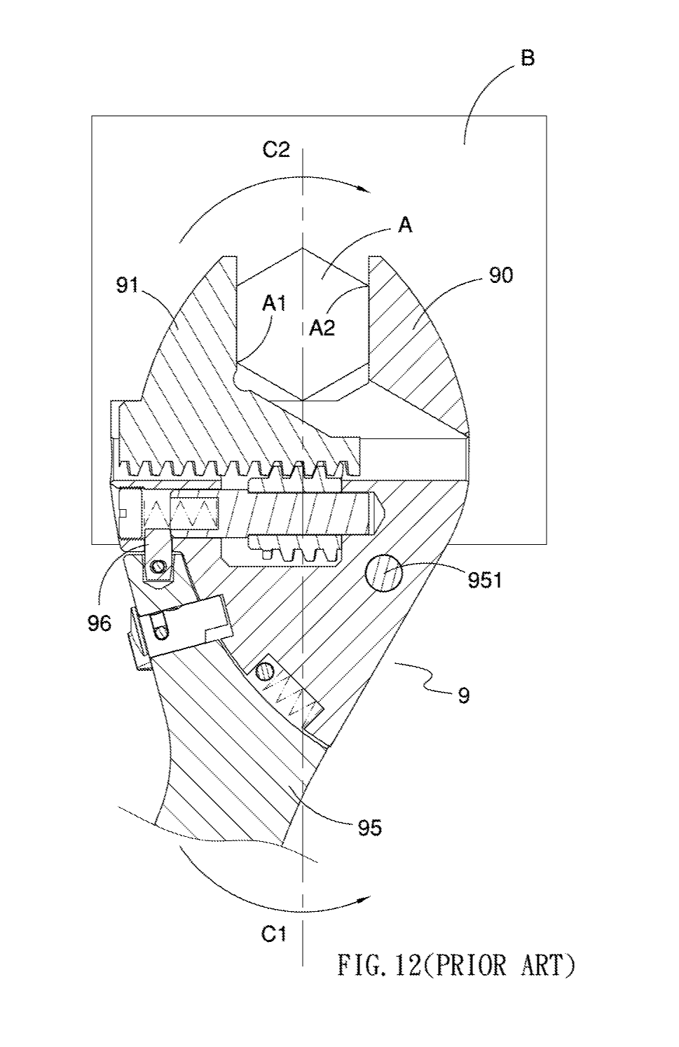

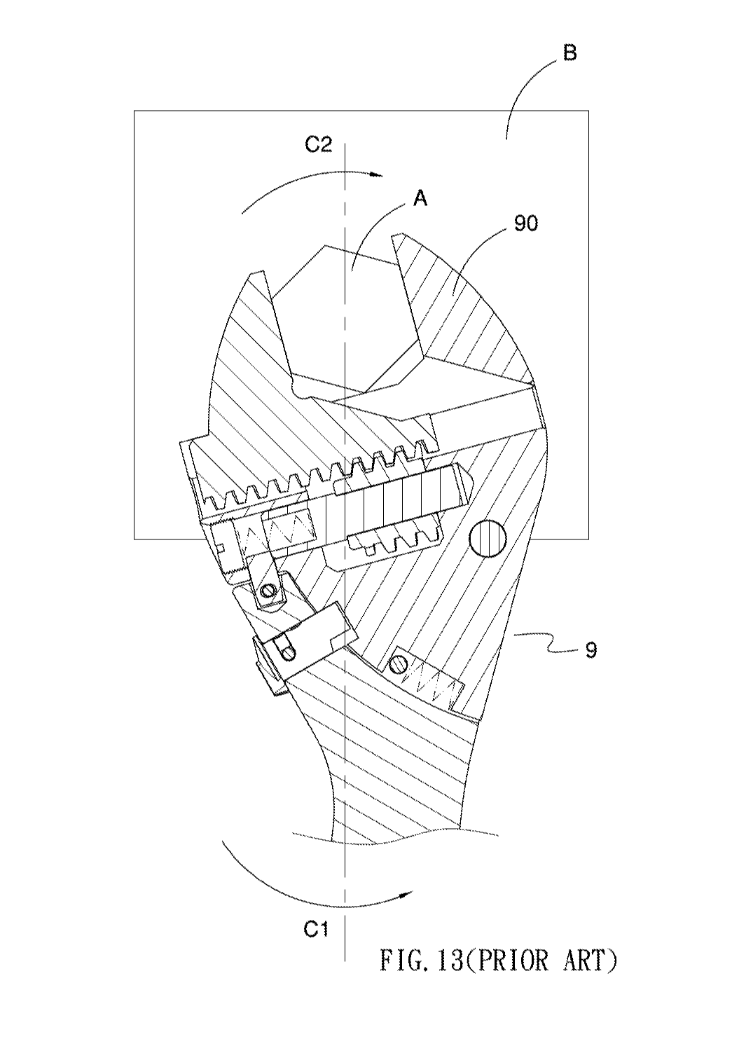

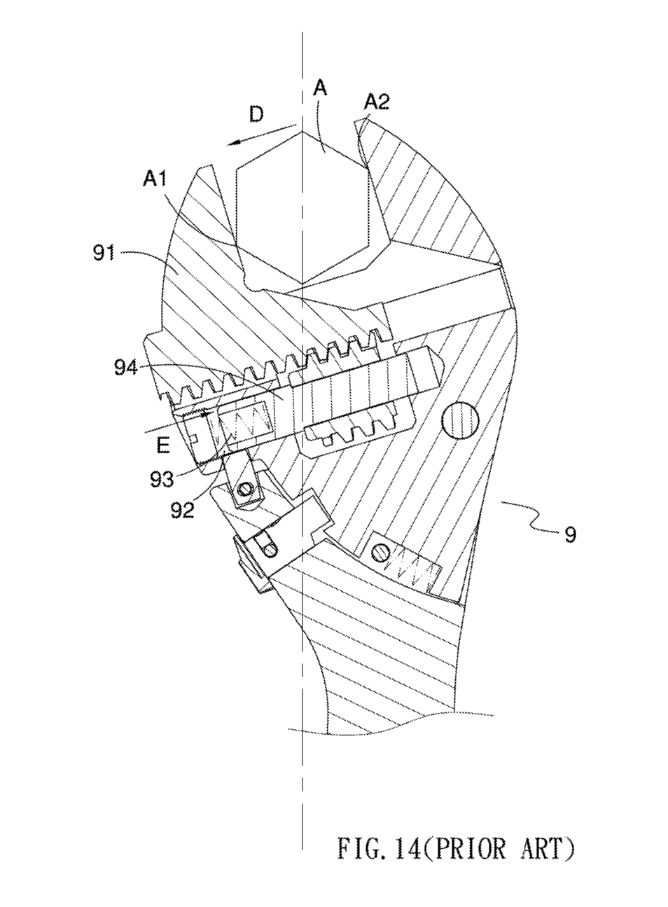

FIG. 10 is a perspective view showing the operable ratchet wrench is switched to a traditional mode in accordance with an embodiment of the present invention. The direction shown by an arrow labeled in FIG. 10 is related to the switch assembly 8 being moved at the lock position H (as shown in FIG. 4). The switch assembly 8 is inserted in the first groove 241, which renders the handle 4 being restrained by the switch assembly 8. This renders that the stop pin 61 cannot be withdrawn either. Therefore, it is believed that the operable ratchet wrench 1 cannot drive the hexagonal nut A to rotate reversibly in the traditional mode, but only operated normally in the traditional mode.

FIG. 11 is a perspective view of another embodiment of the present invention. In this embodiment, configurations and functions of the operable ratchet wrench 1 is substantially identical to that of in the previously mentioned embodiment. The differences between this embodiment and the aforementioned embodiment are the ratchet wrench comprises a driving bulge 48 instead of the driving notch 46. The driving bulge 48 juts out from the sector block 24 and is located in a position where is close to the bottom meeting apex of the sector block 24 and the pivot trench 40. This evidences that the driving bulge 48 juts out from the pivot trench 40, and is uncovered by the handle 4. As such, it is achieved to the ratcheting function that the handle 4 is reversibly rotated with respect to the hexagonal nut A about the pivot axle 42 and drives the stop pin 61 being withdrawn as well by pressing the driving bulge 48 without keeps the fixing jaw 2 fixed.

It is unquestionably evidenced that the prevent invention can be configured with another component with similar functions, which allows the handle 4 being reversibly rotated about the pivot axle 42 and drives the stop pin 61 being withdrawn as well by pressing thereon.

Accordingly, the operable ratchet wrench 1 of the present invention is configured to maintain its ratcheting function and to be capable of being reversibly rotated after disengage the hexagonal nut A. Meanwhile, the slidable jaw 3 can be efficiently moved away from the fixing jaw 2 when reversibly rotating the operable ratchet wrench 1. The operable ratchet wrench 1 of the present invention is further configured with a switch assembly 8 adjacent to a position where the user's thumb is when holding it for easily operating.

It will be appreciated that although a particular embodiment of the invention has been shown and described, modifications may be made. It is intended in the claims to cover such modifications which come within the spirit and scope of the invention.

The invention claimed is:

1. An operable ratchet wrench comprising:
a fixing jaw including a body and a sector block extending from a bottom of the body, the body having a sliding rail, a receiving slot communicating with the sliding rail, a through bore parallel with the sliding rail and a connecting bore communicating with the through bore, the through bore communicating with the receiving slot, the sector block having a first groove defined in an arc edge of the sector block;
a slidable jaw including a sliding rod slidably disposed in the sliding rail of the fixing jaw;
a worm shaft having an axial bore defined therethrough, the worm shaft installed in the receiving slot of the fixing jaw and engaged with a toothed portion of the sliding rod of the slidable jaw;
an axial rod inserted through the through bore, the receiving slot and the axial bore of the worm shaft, the axial rod being axially movable in the through bore along an axial direction thereof, the axial rod having a stop portion stopping against a bottom rim of the worm shaft;
a spring disposed in the through bore for allowing the axial rod being elastically movable along the axial direction;
a handle having a pivot trench defined in a head portion thereof for receiving the sector block therein, the handle pivoted on a vertex of the sector block, the handle being swung with respect to the sector block, wherein the handle further has a recess facing the connecting bore of the fixing jaw;
a stop pin, a top section of the stop pin inserted through the connecting bore of the fixing jaw and entering in the through bore to abut against the axial rod, a bottom section of the stop pin entering in the recess of the handle and pivoted with the handle; and
a driving notch dented in the pivot trench, the driving notch located in a position where is close to a bottom meeting apex of the sector block and the pivot trench so as to uncover a part of the sector block from the pivot trench.

2. An operable ratchet wrench comprising:
a fixing jaw including a body and a sector block extending from a bottom of the body, the body having a sliding rail, a receiving slot communicating with the sliding rail, a through bore parallel with the sliding rail and a connecting bore communicating with the through bore, the through bore communicating with the receiving slot, the sector block having a first groove defined in an arc edge of the sector block;
a slidable jaw including a sliding rod slidably disposed in the sliding rail of the fixing jaw;
a worm shaft having an axial bore defined therethrough, the worm shaft installed in the receiving slot of the fixing jaw and engaged with a toothed portion of the sliding rod of the slidable jaw;
an axial rod inserted through the through bore, the receiving slot and the axial bore of the worm shaft, the axial rod being axially movable in the through bore along an axial direction thereof, the axial rod having a stop portion stopping against a bottom rim of the worm shaft;
a spring disposed in the through bore for allowing the axial rod being elastically movable along the axial direction;
a handle having a pivot trench defined in a head portion thereof for receiving the sector block therein, the handle pivoted on a vertex of the sector block, the handle being swung with respect to the sector block, wherein the handle further has a recess facing the connecting bore of the fixing jaw;
a stop pin, a top section of the stop pin inserted through the connecting bore of the fixing jaw and entering in the through bore to abut against the axial rod, a bottom section of the stop pin entering in the recess of the handle and pivoted with the handle; and
a driving bulge jutting out from the sector block, the driving bulge located in a position where is close to a bottom meeting apex of the sector block and the pivot trench so as to uncover the driving bulge from the pivot trench.

3. An operable ratchet wrench comprising:
a fixing jaw including a body and a sector block extending from a bottom of the body, the body having a sliding rail, a receiving slot communicating with the sliding rail, a through bore parallel with the sliding rail and a connecting bore communicating with the through bore, the through bore communicating with the receiving slot, the sector block having a first groove defined in an arc edge of the sector block;
a slidable jaw including a sliding rod slidably disposed in the sliding rail of the fixing jaw;
a worm shaft having an axial bore defined therethrough, the worm shaft installed in the receiving slot of the fixing jaw and engaged with a toothed portion of the sliding rod of the slidable jaw;
an axial rod inserted through the through bore, the receiving slot and the axial bore of the worm shaft, the axial rod being axially movable in the through bore along an axial direction thereof, the axial rod having a stop portion stopping against a bottom rim of the worm shaft;
a spring disposed in the through bore for allowing the axial rod being elastically movable along the axial direction;
a resilient element disposed in the fixing jaw in a compression state and abutting against the axial rod;
a handle having a pivot trench defined in a head portion thereof for receiving the sector block therein, the handle pivoted on a vertex of the sector block, the handle being swung with respect to the sector block, wherein the handle further has a recess facing the connecting bore of the fixing jaw; and
a stop pin, a top section of the stop pin inserted through the connecting bore of the fixing jaw and entering in the through bore to abut against the axial rod, a bottom section of the stop pin entering in the recess of the handle and pivoted with the handle.

4. The operable ratchet wrench of claim 3, further comprising a driving notch dented in the pivot trench of the handle, wherein the driving notch is located in a position where is close to a bottom meeting apex of the sector block and the pivot trench so as to uncover a part of the sector block from the pivot trench

5. The operable ratchet wrench of claim 3, further comprising a driving bulge jutting out from the sector block, wherein the driving bulge is located in a position where is close to a bottom meeting apex of the sector block and the pivot trench so as to uncover the driving bulge from the pivot trench.

6. The operable ratchet wrench as in claim 1, further comprising a switch assembly, the switch assembly installed in a switch slot that is defined through a wide wall of the pivot trench, the switch assembly being movable in the switch slot, the switch assembly having a unlock position where allows the switch assembly moving thereto to keep the switch assembly away from the first groove and a lock position where allows the switch assembly moving thereto to enable the switch assembly entering in the first groove.

7. The operable ratchet wrench as in claim 1, wherein the handle further includes a through hole defined through a narrow wall of the pivot trench and communicating with the pivot trench, the through hole being perpendicular to the switch slot, the through hole located in a position where is adjacent to the recess and faces the first groove of the sector block, the through hole communicating with the switch slot; and wherein the switch assembly includes a control piece and a locking post, the locking post disposed in the through hole and being movable to the first groove, the control piece having an engaging end that enters in the switch hole and the through hole, the engaging end of the control piece connected to the locking post, and the control piece further having a control end protruding from the switch hole.

8. The operable ratchet wrench as in claim 1, further comprising a return assembly, wherein the return assembly includes a return spring and an axle, the return spring disposed in a second groove that is defined in the arc edge of the sector block, the axle securely disposed in the handle, a portion of the axle located in the second groove and abutting against the return spring.

9. The operable ratchet wrench as in claim 2, further comprising a switch assembly, the switch assembly installed in a switch slot that is defined through a wide wall of the pivot trench, the switch assembly being movable in the switch slot, the switch assembly having a unlock position where allows the switch assembly moving thereto to keep the switch assembly away from the first groove and a lock position where allows the switch assembly moving thereto to enable the switch assembly entering in the first groove.

10. The operable ratchet wrench as in claim 2, wherein the handle further includes a through hole defined through a narrow wall of the pivot trench and communicating with the pivot trench, the through hole being perpendicular to the switch slot, the through hole located in a position where is adjacent to the recess and faces the first groove of the sector block, the through hole communicating with the switch slot; and wherein the switch assembly includes a control piece and a locking post, the locking post disposed in the through hole and being movable to the first groove, the control piece having an engaging end that enters in the switch hole and the through hole, the engaging end of the control piece connected to the locking post, and the control piece further having a control end protruding from the switch hole.

11. The operable ratchet wrench as in claim 2, further comprising a return assembly, wherein the return assembly includes a return spring and an axle, the return spring disposed in a second groove that is defined in the arc edge of the sector block, the axle securely disposed in the handle, a portion of the axle located in the second groove and abutting against the return spring.

12. The operable ratchet wrench as in claim 3, further comprising a switch assembly, the switch assembly installed in a switch slot that is defined through a wide wall of the pivot trench, the switch assembly being movable in the switch slot, the switch assembly having a unlock position where allows the switch assembly moving thereto to keep the switch assembly away from the first groove and a lock position where allows the switch assembly moving thereto to enable the switch assembly entering in the first groove.

13. The operable ratchet wrench as in claim 3, wherein the handle further includes a through hole defined through a narrow wall of the pivot trench and communicating with the pivot trench, the through hole being perpendicular to the switch slot, the through hole located in a position where is adjacent to the recess and faces the first groove of the sector block, the through hole communicating with the switch slot; and wherein the switch assembly includes a control piece and a locking post, the locking post disposed in the through hole and being movable to the first groove, the control piece having an engaging end that enters in the switch hole and the through hole, the engaging end of the control piece connected to the locking post, and the control piece further having a control end protruding from the switch hole.

14. The operable ratchet wrench as in claim 3, further comprising a return assembly, wherein the return assembly includes a return spring and an axle, the return spring disposed in a second groove that is defined in the arc edge of the sector block, the axle securely disposed in the handle, a portion of the axle located in the second groove and abutting against the return spring.
